(19) United States
(12) Patent Application Publication
(10) Pub. No.: US 2009/0156715 A1
(43) Pub. Date: Jun. 18, 2009

(54) EPOXY COMPOSITIONS COMPRISING AT LEAST ONE ELASTOMER AND METHODS RELATING THERETO

(76) Inventors: THOMAS EUGENE DUEBER, Wilmington, DE (US); Barbara Ann Wood, Wilmington, DE (US); Charles John Talkowski, Wilmington, DE (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(21) Appl. No.: 11/956,900

(22) Filed: Dec. 14, 2007

(51) Int. Cl. C08K 3/04; C08K 3/22; C08K 3/28; C08K 3/38; C08K 3/32; C08K 3/34; C08K 5/17; C08K 5/51

(52) U.S. Cl. 524/100; 524/540; 524/413; 524/408; 524/436; 524/403; 524/404; 524/437; 524/432; 524/415; 524/451; 524/147

(57) ABSTRACT

The present disclosure relates to an epoxy composition. The epoxy composition contains an epoxy resin, a phenolic resin, a functional filler, an epoxy cure catalyst and at least one elastomer. The elastomer is used to increase the flexibility of the epoxy composition.

### FIELD OF DISCLOSURE

This disclosure relates generally to epoxy compositions and more specifically to filled epoxy phenolic compositions comprising at least one elastomer.

### BACKGROUND OF THE DISCLOSURE

A need exists for a flexible epoxy composition that can be used during electronic component fabrication without cracking or tearing, particularly in applications where the composition contains relatively large amounts of filler to meet desired electrical properties.

U.S. Pat. No. 4,578,315 to Santorelli relates to a flexible adhesives, suitable for flexible circuitry and able to withstanding high temperature soldering and etching. The adhesive taught in Santorelli comprises a phenol-aldehyde resin, an epoxy resin, and an ethylene-acrylic elastomer and can be either applied in solution form or cast as a free-standing film that is later heated and compressed to provide adhesive properties.

### SUMMARY

The present disclosure is directed to an epoxy composition having 5 to 40 weight % epoxy resin, 5 to 50 weight % phenolic resin, from 1 to less than 10 weight % ethylene copolymer elastomer, from 10 to 88 weight % functional filler, and 0.1 to 5 weight % epoxy cure catalyst.

### DETAILED DESCRIPTION OF THE PREFERRED EMBODIMENT(S)

The present disclosure is directed to a flexible epoxy composition comprising:
1. epoxy resin in a range between (and optionally including) any two of the following: 5, 7, 10, 12, 15, 18, 20, 22, 25, 28, 30, 32, 35, 37, and 40 weight %;
2. phenolic resin in a range between (and optionally including) any two of the following: 5, 7, 10, 12, 15, 18, 20, 22, 25, 28, 30, 32, 35, 37, 40, 42, 45, 47, 48, and 50 weight %;
3. at least one ethylene copolymer elastomer,
4. a functional filler, and
5. an epoxy cure catalyst.

As used herein, epoxy resin refers to resins that contain 2 or more epoxy functional groups. Although not intending to be limited to specific epoxy resin structures, useful epoxy resins in accordance with the present disclosure includes bisphenol A epoxy resins and bisphenol F epoxy resins, phenol novolac epoxy resins, polycyclic epoxy resins (such as, dicyclopentadiene type epoxy resins) and mixtures thereof. Epoxy resins tend to be relatively inexpensive and tend to have relatively advantageous dimensional stability, electrical insulating properties, bonding properties and chemical resistance. The epoxy resin may be a liquid, solid or mixture of both. Epoxy resins useful in the practice of the present invention are commercially available or can be made by techniques well know in the art.

As used herein, phenolic resin refers to resins that contain phenolic functionality and that can react with epoxy groups during thermal cure, generally above 150 degrees C. The phenolic resin is generally, but not necessarily, a thermal crosslinking agent, and can be added to the compositions of the present disclosure to provide additional crosslinking functionality. In one embodiment, the thermal crosslinking agent stabilizes the composition, raising the Tg (glass transition temperature) of the composition, increasing chemical resistance, and increasing thermal resistance of the cured composition. The phenolic resin can react with the epoxy resin to form a more moisture resistant composition than the epoxy resin alone. Useful phenolic resins include dicyclopentadiene phenolic resins, phenol formaldehyde novolac resins, bisphenol A-formaldehyde novolac resins, cresol formaldehyde phenolic resins and mixtures thereof. The phenolic resin can be present in the amount between and including any two of the following: 5, 7, 10, 12, 15, 17, 20, 22, 25, 27, 30, 32, 35, 37, 40, 42, 45, 47 and 50 weight %. Useful phenolic resins of the present disclosure are commercially available or can be made by techniques well know in the art.

The epoxy resin composition also comprises a functional filler. The functional filler of the present disclosure is any material, when added to the composition, imparts one or more intended electrical, thermally conductive or flame retardant properties. The amount of functional filler used in the epoxy resin composition will depend on the desired properties. In some embodiments, to obtain the desired electrical properties, high filler loading may be necessary, e.g., loadings greater than 30, 40, 50, 60, or 70 weight percent. In some embodiments, the functional filler is a material that increases the dielectric constant of the epoxy composition. In some embodiments, the functional filler is a high dielectric constant filler. The term “high dielectric constant” is intended to mean a dielectric constant of at least 50. In some embodiments, the high dielectric constant filler has a dielectric constant of at least 50, 75, 100, 150 or 200. In some embodiments, the high dielectric constant filler is selected from those having a dielectric constant between in a range between (and optionally including) any two of the following: 50, 60, 75, 100, 150, 200, 250, 300, 500, 1000, 2000, 5000, 7500 and 10,000. In some embodiments, useful functional fillers to increase the dielectric constant of the epoxy composition are selected from a group consisting of TiO₂, Ta₂O₅, Hf₂O₅, Nb₂O₅, Al₂O₃, Steatite, BaTiO₃, SrTi0₃, BaSrTi0₃, PbZrTiO₃, PdLaTiO₃, PdLaTiO₃, PdLaZrTiO₃, PdMgNbO₃, CaCuTiO₃ and mixtures thereof.

The addition of a high dielectric constant filler generally increases the dielectric constant of the epoxy composition. The term “dielectric constant” herein denotes the electrostatic energy stored per unit volume for unit potential gradient and is the ratio of the capacitance of a material to the capacitance resulting when the material is replaced by air or vacuum. The dielectric constant is equal to the (capacitance (nanoFarads)×dielectric thickness (microns)×1.13)/area of capacitor (cm²).

The term “capacitance” herein denotes a measure of the amount of electric charge stored for a given electric potential. The capacitance can be calculated if the geometry of the conductors and the dielectric properties of the dielectric between the conductors are known. Capacitance is proportional to the surface area of the conductor and inversely proportional to the distance between the conductors. Increasing the dielectric constant of the epoxy composition increases the amount of electrical energy capable of being stored without increasing the size of a capacitor. A capacitor is a device whose function is to store electrical energy. It is made of two conductive layers separated by an insulating or dielectric material. It blocks the flow of direct current, and allows the flow of alternating current.

In some embodiments, the dielectric constant of the epoxy composition is between and optionally including any two of the following numbers 9, 11, 17, 19, 21, 23 and 25. Methods for determining dielectric constant are described in ASTM D150, “Standard Test Methods for AC Loss Characteristics and Permittivity (Dielectric Constant) of Solid Electrical Insulation”. The capacitance can be measured using an HP 4284A 20 Hz-1 MHz Precision LCR Meter. In some embodiments, the capacitance of the epoxy composition is between (and optionally including) any two of the following numbers 0.64, 0.68, 0.70, 0.74, 0.78, 0.81, 0.84, 0.88, 0.90, 0.94, 0.98, 1.00, 1.1, 1.2, 1.3, 1.4, 1.5, 1.6, and 1.66 nF/cm².

Unwanted leakage current is a common disadvantage of high dielectric constant fillers. Leakage current is an undesirable amount of current that flows through an insulator between two electrodes. This undesirable flow of current through an insulator drains charge on the capacitor. Leakage current is measured by applying a potential between two electrodes and across the dielectric layer. The current between the two electrodes is measured. The current measured would be the leakage current. In some embodiments, the leakage current of a 12 micron thick epoxy composition, when laminated between two copper films, at 500 volts DC, is between and optionally including 0.080, 0.085, 0.090, 0.095, 0.098, 0.10 and 0.15 microamps/cm². In some embodiments, the leakage current of the epoxy composition, when laminated between two copper films, at 750 volts DC is between and optionally including 0.004, 0.008, 0.010, 0.015, 0.020, 0.025, 0.030, 0.033, 0.035, 0.040, 0.050, 0.060, 0.070, 0.080, and 0.082 microamps/cm².

In some embodiments, the functional filler is a thermally conductive filler. In some embodiments, the thermally conductive functional filler is selected from the group consisting of aluminum oxide, silica, boron nitride, boron nitride coated aluminum oxide, granular alumina, granular silica, fumed silica, silicon carbide, aluminum nitride, aluminum oxide coated aluminum nitride, titanium dioxide, dicalcium phosphate, barium titanate, titanium diboride, cubic boron nitride, diamond, calcium fluoride, talc, zinc oxide and mixtures thereof. In some embodiments, the functional filler is a flame retardant. In some embodiments, the flame retardant is halogen-free flame retardant. In some embodiments, the flame retardant is a halogen-free polyphosphate or phosphonate flame retardant.

In some embodiments, the flame retardant is a nitrogen-containing condensed phosphoric acid compound. In some embodiments, the flame retardant is selected from the group consisting of ammonium polyphosphate, polyphosphoric acid amide, ammonium polyphosphoric acid amide, carbamyl polyphosphate, melamine polyphosphate, melamine pyrophosphate, resorcinol polyphosphate and mixtures thereof. In some embodiments, the functional filler is selected from the group consisting of melamine polyphosphate, melamine pyrophosphate, resorcinol polyphosphate and mixtures thereof. The functional filler present in the amount between and including 10, 15, 20, 25, 30, 35, 40, 45, 50, 55, 60, 65, 70, 75, 80, 85 and 88 weight %.

The functional filler can be any shape, including regularly or irregularly shaped and may have a smooth or rough surface texture. In some embodiments fillers of different shapes are used. In some embodiments the filler is particulate. In some embodiments, fillers having different textures are used. In some embodiments, the filler particle has portions of the surface that are smooth and other portions that are rough. In some embodiments, the functional filler may be coated. In some embodiments, the coating can be a single layer or more than one layer, continuous or non-continuous, on the surface of the filler. In some embodiments, a continuous uniform coating is desired.

The epoxy resin composition additionally comprises an epoxy cure catalyst. The epoxy cure catalyst lowers the cure temperature requirement for crosslinking of the epoxy composition. In the present disclosure, the epoxy cure catalyst lowers the cure temperature at which the epoxy resin reacts with the phenolic resin. Useful epoxy cure catalysts are tertiary amines or mixtures thereof. Any tertiary amine would be useful as long as the tertiary amine is not so volatile that it would be removed upon drying. In some embodiments, the epoxy catalyst is selected from the group consisting of 2-ethyl-4-methylimidazole, N,N-dimethylbenzylamine and mixtures thereof. The epoxy cure catalyst is present in an amount between and including 0.1, 0.4, 0.8, 1.0, 1.4, 1.8, 2.0, 2.4, 2.8, 3.0, 3.4, 3.8, 4.0, 4.4, 4.8 and 5.0 weight %.

The epoxy resin composition comprises an elastomer. The term “elastomer” herein denotes a material that when cured (crosslinked) and is deformed under stress or external forces, but is able to return to its original shape when the stress or force is removed. The elastomer imparts flexibility to the cured epoxy composition. For the purposes of this disclosure, an elastomer is a flexibilizer and the terms may be used interchangeably.

The term “flexibilizer” herein denotes any material, when added to a resin, makes the resin more flexible. The term “flexible” herein denotes the ability to bend or be handled without cracking or tearing. Generally, epoxy resin compositions are brittle. Epoxy resin compositions become especially brittle with high filler loading. Without the addition of a flexibilizer, some epoxy resin compositions are too brittle to handle. The addition of the flexibilizer allows handling of a free-standing cured epoxy film without cracking or tearing. The ability to handle a free-standing cured epoxy film without cracking or tearing provides a processing advantage when fabricating multilayer circuit boards and other electronic components. The elastomer or a mixture of elastomers is present in the amount between and including 1, 3, 5, 7, 9, 11, 13, 15, 17 and 20 weight %. In some embodiments, the elastomer is highly crosslinked, including elastomer with such a high degree of crosslinking that the elastomer has little, if any, elastomeric properties on a macro (or visibly observable with the naked eye) scale.

In some embodiments, the elastomer is a thermoplastic resin. In some embodiments, the elastomer is an ethylene copolymer elastomer. In some embodiments, the ethylene copolymer elastomer comprises ethylene and an acrylate. The ethylene is present in the amount between and including 37, 38, 39, 40, 41, 42 and 43 weight %. The acrylate is present in the amount between (and optionally including) any two of the following: 50, 55, 56, 57, 58, 59, 60, 61, 62 and 63 weight %.

In some embodiments the acrylate is selected from methyl acrylate, ethyl acrylate, butyl acrylate, methoxy ethyl acrylate, ethoxy ethyl acrylate and mixtures thereof. In some embodiments, the acrylate is methyl acrylate. In some embodiments, methyl acrylate is present in the amount between and including 65, 70, 75, 80, 85, 90, 95 and 100 weight % relative to the total weight of the acrylate component. In some embodiments, when the acrylate is methyl acrylate, additional acrylates may be present in an amount between and including 0, 5, 10, 15, 20, 25, 30 and 35 weight %. In some embodiments, the ethylene copolymer elastomer comprises ethylene, an acrylate and an additional component selected from but not limited to:
i. from 0, 0.25, 0.5, 0.75, 1, 2, or 3 to 6 weight percent maleic acid and derivatives thereof,
ii. up to 35 weight percent acrylic acid and derivatives thereof,
iii. from 0, 0.25, 0.5, 0.75, 1, 2, or 3 to 6, 7, 8, or 9 weight percent of glycidyl methacrylate and mixtures thereof.

In some embodiments, the ethylene copolymer elastomer comprises ethylene, an acrylate and from 0, 0.25, 0.5, 0.75, 1, 2, or 3 to 6 weight percent of a mono alkyl ester of maleic acid wherein the alkyl group is selected from methyl, ethyl, propyl, butyl and mixtures thereof. In another embodiment, the ethylene copolymer elastomer comprises ethylene, an acrylate and a glycidyl methacrylate. In another embodiment, the ethylene copolymer elastomer comprises ethylene, an acrylate and a mixture of a mono alkyl ester of maleic acid and glycidyl methacrylate. In some embodiments, the mono alkyl ester of maleic acid is present in an amount between and including 0, 1, 2, 3, 4, 5 and 6 weight %. In some embodiments, the glycidyl methacrylate is present in an amount between and including 0, 1, 2, 3, 4, 5, 6, 7, 8 and 9 weight %.

Other flexibilizers found to be useful in the epoxy resin composition are core shell polymers and polyaramide nanopulp. The term “core-shell polymer” herein denotes a particle comprising a core and a shell layer (the shell layer covers the core). The core may or may not be completely covered by the shell layer. The core comprises an elastomeric, low glass transition temperature (Tg) polymer which is in a rubbery state at room temperature. The shell is a different polymer that has a much higher Tg and is in a glass state at room temperature. In some embodiments, the elastomeric cores are selected from a group consisting of polybutadiene, polystyrene/butadiene, polysiloxane and mixtures thereof. The core shell polymer is present in an amount between (and optionally including) any two of the following: 0, 1, 2, 3, 4, 5, 6. 7. 8. 9. 10, 11, 12, 13, 14, 15 weight %.

Polyaramide nanopulp can be a useful filler for many embodiments of the present invention and is a wholly aromatic polyamide microfiber that has a mean fiber length typically of 2, 4, 5, 10, 20 or 25 microns, a fiber width that is typically from 50 to 100 nm and a fiber thickness that is typically less than 10 nm. The core shell polymer is present in the amount between (and optionally including) any two of the following: 0, 1, 2, 3, 4, 5 and 6 weight %. In one embodiment, the polyaramide nanopulp is present in the amount between and including 0, 1, 2 and 3 weight %.

In some embodiments, the epoxy resin composition contains an ethylene copolymer elastomer as the flexibilizer. In some embodiments, the epoxy resin composition contains a core shell polymer as the flexibilizer. In some embodiments, the epoxy resin composition contains a polyaramide nanopulp as the flexibilizer. In other embodiments, the flexibilizer is selected from two or more of the following, ethylene copolymer elastomer, core shell polymer and polyaramide nanopulp.

The composition may also include other additives such as dispersion agents, adhesive agents, stabilizers, antioxidants, leveling agents, rheology control agents, flame retardants, plasticizers, lubricants, static control agents, processing aids and any other additive commonly used in the art provided they do not detrimentally affect the desired properties of the composition.

In some embodiments, the epoxy composition can be in the form of a film. The term “film” herein denotes a free standing film or a coating on a substrate. In some embodiments, the composition is in the form of a laminate. The term “laminate” herein denotes a material constructed by uniting two or more layers of material together. The materials can be the same or different. In one embodiment the laminate comprises at least one metal layer and one epoxy layer. In another embodiment, the laminate comprises more than one metal layer and at least one epoxy layer. In another embodiment the laminate comprises more than one metal layer and more than one epoxy layer. In some embodiments, the metal layer is on one side of the epoxy layer. In other embodiments, a metal layer is on both sides of the epoxy layer. In some embodiments the metal layer can be gold, titanium, silver, and alloys thereof. In other embodiments, the metal layer is copper. The laminate can be produced by any of the conventional methods used by one skilled in the art, including, but not limited to:
i. extrusion die casting of the coating mixture or dispersion, such as:
   a. the coating dispersion can be cast directly onto conductive metal foil; or
   b. the coating dispersion can be cast as a free-standing film by casting onto a drum, belt, release film, glass plate, or other suitable substrate and subsequently laminating or bonding to the conductive metal foil;
ii. wet coating methods, such as:
   a. spray coating,
   b. spin coating,
   c. dip coating,
   d. gravure coating,
   e. “Doctor Blade”,
   f. drawdown rod,
   g. wire wound rod,
   h. casting knife,
   i. air knife,
   j. roll, brush,
   k. squeeze roll,
   l. kiss roll, and
   m. the like
      onto the conductive metal foil.

In one embodiment, the laminate comprises one metal layer and one epoxy layer, where the epoxy layer is vacuum laminated to a metal foil and hot pressed to form a laminate from which capacitors can be made. In such an embodiment, the epoxy layer can comprise conductive metal on both sides. In some embodiments, the capacitor thickness is between (and optionally including) any two of the following: 12.8, 13.0, 13.2, 13.4, 13.8, 14.0, 14.2, 14.4, 14.6, 14.8 and 15.0 microns.

Elongation to break, tensile strength and peel strength are test methods used for the present disclosure to evaluate flexibility of the epoxy resin compositions. Elongation to break, tensile strength measurements use freestanding cured epoxy compositions in the form of a film. The measurements are made using an Instron. In order to obtain the freestanding cured epoxy film, a dispersion of the epoxy composition is prepared.

The dispersion is coated on a metal film (foil) and dried. The epoxy coated metal film is vacuum laminated to a non-coated metal film in a hot press to form a laminate. In some embodiments the metal film is copper. In some embodiments, all of the metal is etched to obtain the free standing film. The epoxy films produced for Instron testing are generally thicker than conventional capacitor laminates due to the limitation of the sample size required for the equipment. In some embodiments, the film thickness is between and including any two of the following numbers 0.5, 1.0, 1.1, 1.2, 1.3, 1.4, 1.5, 1.6, 1.7 and 1.8 mils.

In some embodiments, the elongation to break is between (and optionally including) any two of the following: 1.5, 2.0, 3.6, 4.0, 4.2, 4.3, 4.5, 5.0, 5.1, 5.5, 5.6, 6.0,6.5, 6.7, 7.0, 7.3, 7.5, 8.0, 8.5, 9.0, 9.5, 10.0, 10.5, 11.0, 11.5, 12.0, 12.2 and 12.5%. In some embodiments, the tensile strength is between (and optionally including) any two of the following: 300, 321, 352, 375, 400, 417, 464, 470, 500, 534, 572, 600, 620, 650, 680, 700, 717 and 750 kg/cm². Peel strength measurements can use the capacitor laminate formed by hot pressing. Peel strength of capacitor metal laminates can be measured using a German Wheel with the Instron.

Peel strength is generally measured to assure the composition adheres to the substrate and to assess if the composition in the form of a film is flexible enough to give good peel strength. If the film composition is too brittle, even with good adhesion, the peel strength will be low. If the film composition is flexible but has low adhesion, the peel strength will be low. In some embodiments, the peel strength is between and including any two of the following numbers 0.35, 0.40, 0.43, 0.45, 0.50, 0.55, 0.58, 0.60, 0.64, 0.66, 0.70, 0.75, 0.80, 0.85, 0.90, 0.95, 0.98, 1.05, 1.10 and 1.15 kg/cm.

In one embodiment, the epoxy composition is used as a dielectric layer in a planar capacitor. A planar capacitor is a flat film sheet, which is unfilled or filled that contains capacitors composed of a dielectric layer in between two copper layers. In some embodiments, the planar capacitor layer is prepared by coating the filled dielectric layer on copper foil. A second copper foil is laminated to this coated copper with a hot press lamination. A layer containing capacitors is fabricated either in steps or with double side processing. The capacitors are prepared using photoresist processing. If the composition does not have high enough strength to withstand cracking or tearing, the one-side imaged sheet is laminated with prepreg with the capacitor detail towards the circuit board, and then the top side copper layer is photoresist processed to complete the capacitors. If the sheet has good film strength the capacitors can be formed with double side processing and then laminated with prepreg to the circuit board. A thin polyaramide film can be laminated between two layers of coated copper foils so that the resultant laminate has enhanced resistance to tearing and improved double side processing capability. In one embodiment, the polyaramide film is about 1, 2, 3, 4, 5, 6, 7, 8, 9, or 10 microns thick.

In another embodiment, the epoxy composition is used as a layer in a thermal laminate. The term, “thermal laminate” is intended to denote a material constructed by uniting two or more layers, wherein at least one of the layers conducts heat. In some embodiments, the thermal laminate has a z-axis thermal conductivity of at least about 0.25, 0.5, 0.75, 1, 1.2, 1.5, 1.75 or 2 W/m° K. In another embodiment, the epoxy composition is used as a flame retardant adhesive composition. In some embodiments, the flame retardant adhesive composition on 1 mil thick polyimide film passes the UL-94 VTM-0 test.

The term “cure” herein is intended to denote polymerization, optionally also including cross-linking. Cross-linking is intended to mean the attachment of two polymer chains by bridges of an element, a molecular group, or a compound, and can sometimes take place or otherwise initiate upon heating.

The term “dielectric” herein denotes a nonconductive material having high resistance to the flow of electric current. A dielectric can serve as an insulator, because it has poor electrical conductivity and is capable of storing electrical energy.

As used herein, the terms “comprises,” “comprising,” “includes,” “including,” “has,” “having” or any other variation thereof, are intended to cover a non-exclusive inclusion. For example, a method, process, article, or apparatus that comprises a list of elements is not necessarily limited only those elements but may include other elements not expressly listed or inherent to such method, process, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Also, use of the “a”, “an” or “the” are employed to describe elements and components of the invention. This is done merely for convenience and to give a general sense of the invention. This description should be read to include one or at least one and the singular also includes the plural unless it is obvious that it is meant otherwise.

### EXAMPLES

Many of the advantages of the present invention are illustrated in the following examples. Preparation of compositions, processing and test procedures used in the examples of the present invention are described below.

Dispersion Process

Dispersions were prepared either by sonication using a Branson Digital Sonifier® or by media milling with 0.635 cm magnesia-stabilized zirconia cylinders.

Coating Process

Coating compositions were doctor knife coated on copper foil, Kapton® brand polyimide film as the coating substrates. The process steps involved: (1) adhering the substrate to a clean, flat glass plate by application of a small amount of isopropyl alcohol to the glass plate, (2) applying the coating substrate to the plate and laying a piece of Mylar® brand polyester film over the substrate, (3) adhering the substrate to the plate with a squeegee and removal of the Mylar® brand polyester film. Different doctor knifes were used to provide the thickness of coating that was desired.

Lamination Process

Copper foil was laminated to the coated and dried compositions with a hot vacuum press. A standard press cycle of about (182±12)° C. for one hour at 14.065 Kg/cm was used.

Etching Process

Copper was etched from the cured compositions in an ammonium persulfate solution at room temperature that was prepared by dissolving 500 grams of ammonium persulfate in 1675 grams of DI water and 25 grams of concentrated sulfuric acid.

Capacitor Fabrication and Testing

Using photoresist imaging and copper etching, 2.5 cm diameter capacitors were prepared for testing. Electrical testing of the imaged capacitors showed that they could pass up to 750 volts DC in the dielectric withstanding voltage HiPot test for the half mil thick samples using a Hipontronics H30013 test meter. Capacitance and loss tangent were obtained with a HP4284A meter at 1 MHz. Initial resistance testing was with a Fluke 189 meter.

Dielectric Constant

Methods for determining dielectric constant are described in ASTM D150, “Standard Test Methods for AC Loss Characteristics and Permittivity (Dielectric Constant) of Solid Electrical Insulation”. The composite film dielectric constant was calculated based on the measured capacitance of the 2.5 cm diameter capacitors.

Leakage Current

Leakage current can be measured with a Hipotronics H300B Series HiPot and Megohmmeter at room temperature. A 500 and 750 volt DC potential is applied between the two copper foil electrodes and across the dielectric layer. At this potential the current between the two electrodes is measured and converted to current per unit area of capacitor electrode.

Capacitance

Capacitance can be measured at 1 MHz with a HP 4284A 20 Hz-1 MHz Precision LCR Meter.

Instron Testing

Freestanding cured epoxy compositions of 1.27 cm width, where all of the copper was etched off, were evaluated for elongation-to-break and tensile strength with an Instron. Peel strength of laminates were tested using a German Wheel with the Instron.

Thermal Conductivity Measurement

A cured free standing film is cut with a 2.54 cm diameter puncher. For the thermal conductivity determination a laser flash method is used to determine the thermal conductivity. Samples are sputtered with ˜200 Å of Au layer in order to block the laser flash being seen by the IR detector during the measurement. The gold coating is then sprayed with three coats of micronically fine synthetic graphite dispersion in Fluron®. The graphite coating increases the absorption of radiation on the laser side of the sample, and increases the emission of radiation on the detector side.

The specific heat is determined first by comparing with that of a standard (Pyrex® 7740), and then corrected by subtracting those of gold and graphite coatings. The bulk density is calculated based on the formulation. Thermal diffusivity in the unit of cm/s is obtained via a Netzsh laser flash instrument. The thermal conductivity is calculated as:

Conductivity=(Diffusivity×Density×Specific Heat)

Temperature is controlled at 25° C. via a Neslab circulating batch. Scan time is set at 200 ms with an amperage gain of 660 for Pyrex® standard and 130-200 second and 600 gain for the sample. A Nd:glass laser of 1060 nm and pulse energy of 15 J and pulse width of 0.33 ms is used. Three laser shots are taken for each sample.

Flammability (UL94VTM Test)

Specimens were tested in accordance with the UL 94 Thin Material Vertical Burning Test for classing resist coating materials as 94VTM-0, 94VTM-1 or 94VTM-2. The 94VTM-0 classification is the best rating, indicating significantly reduced flammability.

The following glossary contains a list of names and abbreviations for each ingredient used:
BaTiO₃ filler A Praxair lot 03-P4728BM, D50 (by Horiba measurement) 0.5 microns, 6.07 m²/g surface area
BaTiO₃ filler B BT-01 from Sakai D50 (by Horiba measurement) 0.32 microns, 13.41 m²/g surface area
TiO₂ R-706 DuPont surface treated titanium dioxide with 2.4 wt % alumina, 3.0 wt % silica and treated with trimethylol propane, D50 of 0.36 microns, 11.1 m²/g surface area
Boron nitride Polar Therm™ PT-120 from GE Advanced Materials, D50 of 11 microns, 3.5 m²/g surface area
Melapur® 200 Melamine polyphosphate powder from DSM Nisson Chem.
Durite® ESD-1819 Dicyclopentadiene phenolic resin, equivalent weight of 250, from Borden Chemical, Inc. of Louisville, Ky.
SD-1502 A low MW bisphenol A-formaldehyde novolac from Borden Chemical, Inc. of Louisville, Ky.
SD-1708 A relatively high MW phenol-formaldehyde novolac from Borden Chemical, Inc. of Louisville, Ky.
ESD-1817 A phenol formaldehyde novolac with a high nitrogen content from Borden Chemical, Inc. of Louisville, Ky.
SU-8 High functionality bisphenol A epoxy novolac resin from Resolution Performance Products LLC, WPE of 217
Epon® 1001F Bisphenol F epoxy resin, WPE of 525-550, from Resolution Performance Products LLC
Epon® 1007F Bisphenol F epoxy resin, WPE of 1700-2300, from Resolution Performance Products LLC
Epon® 862 Bisphenol F epoxy resin, WPE of 166-177, from Resolution Performance Products LLC
Vamac® MR Ethylene acrylic elastomer of 41 wt % ethylene, 55 wt % methyl acrylate, 4 wt % of the ethyl ester of maleic anhydride from DuPont
Vamac® VCX 1014 Ethylene acrylic elastomer of 42 wt % ethylene, 55 wt % methyl acrylate, 2.5 wt % of the ethyl ester of maleic anhydride from DuPont
Vamac® GMA Ethylene acrylic elastomer 41 wt % ethylene, 55 wt % methyl acrylate, 4 wt % glycidyl methacrylate from DuPont
MX133 core shell polymer A mixture of 25 wt % of a core shell polymer with a styrene-butadiene core and 75 wt % of a liquid bis F epoxy carrier resin from Kaneka Texas Corp., Houston, Tex.
Kevlar® nanopulp dispersion Dispersion of 10 wt % Kevlar® nanopulp and 90% Epon® 862 epoxy resin from DuPont
Polyamide film 3.8 micron thick Aramica® PPTA Aramide film from Teijin Advanced Films Ltd., Tokyo, Japan
PKHH Ucar® bis phenol A phenoxy resin from Inchem Corp.
EMI 2-ethyl-4-methylbenzimidizole epoxy catalyst from Aldrich Chemical Co.
DICY Dicyandiamide from Aldrich Chemical Co.
Benzotriazole Adhesion promoter from Aldrich Chemical Co.
Dispersant 1 Zephrym® PD7000, 100% solids nonionic surfactant from the Uniqema Division of Imperial Chemical Industries PLC.
Dispersant 2 RCH-87763 DuPont proprietary AB block copolymer dispersant, 40% solids, molecular weight range 7,000 to 12,000

### Example 1

EXAMPLE 1 illustrates a planar capacitor of a highly filled flexible epoxy composition that has a very low leakage current when tested at high voltage. The capacitor coating composition was made by first preparing a dispersion of the functional phase material and then adding the rest of the ingredients. The dispersion was prepared by sonication, for 10 minutes at 0° C. under nitrogen, a mixture of 30.05 grams barium titanate powder, 24.75 grams methyl ethyl ketone (MEK), and 6.04 grams of a previously dissolved solution of 60% solids ESD-1819 in MEK. The dispersion was warmed up to room temperature under nitrogen. To this dispersion was added with stirring, 3.2 grams of a 60% solids solution of ESD-1819 in MEK, 8.87 grams of a 60% solids solution of SU-8 epoxy resin, 7.95 grams of a 30% solids solution of Vamac® MR in MEK and 0.243 grams of a 50% solids solution of EMI in MEK. The dispersion was filtered through three layers of 10 micron filter bag material. The final composition was:

| Ingredient | Dry weight % |
|---|---|
| BaTiO3 filler A | 69.20 |
| ESD-1819 | 12.77 |
| SU-8 | 12.26 |
| Vamac ® MR | 5.49 |
| EMI | 0.28 |

The coating dispersion was coated with a 2 mil doctor knife on Gould RA black treat copper foil that was adhered to a glass plate. After a 10 min dry time at 80° C. the coated copper was vacuum laminated to the treated side of an non-coated piece of Gould RA black treat copper foil in a hot press to form the planar capacitor laminate. After photoresist processing, etching and stripping of the photoresist, 2.54 cm diameter capacitors were obtained. Electrical testing of the 12.8 micron dielectric thick samples gave a capacitance density of 0.81 nF/cm², a dielectric constant of 10.4 and a leakage current at 500 volts DC test voltage of 0.037 μamp/cm².

### Example 2

EXAMPLE 2 illustrates a highly filled flexible epoxy composition that has a good elongation to break and good peel strength. The composition was prepared by mixing a media milled dispersion with the rest of the composition ingredients. The dispersion was prepared from a mixture of:

| Ingredient | Grams |
|---|---|
| TiO₂ R-706 | 20.00 |
| Dispersant 2 | 0.94 |
| ESD-1819 (60% solids in MEK) | 0.89 |
| Vamac ® MR (30% solids in MEK) | 1.24 |
| Vamac ® GMA (30% solids in MEK) | 2.52 |
| MEK | 24.2 |

The mixture was media milled for 4 hours in a bottle that was half filled with 0.25 inch cylinders. The bottle was packed in a one gal bottle and placed on a jar roller that was set at 80 RPM so that the small bottle tumbled end over end. To this dispersion was added 7.89 grams of a 60% solids solution of ESD-1819 in MEK, 9.95 grams of a 60% solids dispersion of Kaneka MX133 in MEK and 0.23 grams of a 50% solids solution of EMI in MEK. The dispersion was filtered through three layers of 10 micron filter bag material. The final composition was:

| Ingredient | Dry weight % |
|---|---|
| TiO₂ | 60.88 |
| ESD-1819 | 16.03 |
| Vamac ® MR | 1.13 |
| Vamac ® GMA | 2.30 |
| MX-133 | 18.17 |
| EMI | 0.35 |
| Dispersant | 1.14 |

Coatings were made with 2 and 7 mil doctor knifes on Gould RA black treat copper foil that was adhered to a glass plate. The coated samples were dried for 10 min at 80° C. The 0.5 mil thick samples from the 2 mil doctor knife coatings were vacuum laminated to the treated side of Gould RA black treat copper foil in a hot press to form the planar capacitor laminate with a peel strength of 1.05 Kg/cm. The thicker dielectric samples were cured in a 170° C. forced draft oven for one hour, and the copper was etched to obtain a 1.3 mil thick free-standing sheet of cured epoxy which had an elongation-to-break of 7.3% and a tensile strength of 416.9 Kg/cm².

### Example 3

EXAMPLE 3 illustrates the use of Kevlar® nanopulp to reinforce a highly filled epoxy composition to increase the tensile modulus. The composition was prepared by mixing a media milled dispersion with the rest of the composition ingredients. The dispersion was prepared from a mixture of:

| Ingredient | Grams |
|---|---|
| TiO₂ R-706 | 20.00 |
| Dispersant 2 | 0.94 |
| Kevlar ® nanopulp (21.91% solids) | 23.80 |
| Vamac ® MR (30% solids in MEK) | 1.23 |
| Vamac ® GMA (30% solids in MEK) | 2.47 |
| MEK | 6.00 |

The mixture was media milled for 4 hours in a bottle that was half filled with 0.635 cm cylinders. The bottle was packed in a one gal bottle and placed on a jar roller that was set at 80 RPM so that the small bottle tumbled end over end. To this dispersion was added 8.71 grams of a 60% solids solution of ESD-1819 in MEK, 2.34 grams of a 60% solids solution of SU-8 epoxy resin and 0.23 grams of a 50% solids solution of EMI in MEK. The dispersion was filtered through three layers of 10 micron filter bag material. The final composition was:

| Ingredient | Dry weight % |
|---|---|
| TiO₂ | 59.80 |
| ESD-1819 | 15.63 |
| SU-8 | 4.20 |
| Vamac ® MR | 1.10 |
| Vamac ® GMA | 2.20 |
| Kevlar ® nanopulp | 15.59 |
| EMI | 0.34 |
| Dispersant | 1.12 |

Coatings were made with 2 and 7 mil doctor knifes on Gould RA black treat copper foil that was adhered to a glass plate. The coated samples were dried for 10 min at 80° C. The 0.5 mil thick samples from the 2 mil doctor knife coatings were vacuum laminated to the treated side of Gould RA black treat copper foil in a hot press to form the planar capacitor laminate with a peel strength of 0.58 Kg/cm. The thicker dielectric samples were cured in a 170° C. forced draft oven for one hour, and the copper was etched to obtain a 1.3 mil thick free-standing sheet of cured epoxy which had an elongation-to-break of 4.2% and a tensile strength of 534 kg/cm2.

### Example 4

EXAMPLE 4 illustrates a planar capacitor highly filled with barium titanate that has excellent electrical performance. The composition was prepared by mixing a media milled dispersion with the rest of the composition ingredients. The dispersion was prepared from a mixture of:

| Ingredient | Grams |
|---|---|
| BaTiO₃ filler B | 30.00 |
| Dispersant 2 | 1.02 |
| ESD-1819 (60% solids in MEK) | 0.91 |
| Vamac ® MR (30% solids in MEK) | 3.79 |
| MEK | 36.0 |

The mixture was media milled for 4 hours in a bottle that was half filled with 0.635 cm cylinders. The bottle was packed in a one gal bottle and placed on a jar roller that was set at 80 RPM so that the small bottle tumbled end over end. To this dispersion was added 8.05 grams of a 60% solids solution of ESD-1819 in MEK, 10.11 grams of a 60% solids dispersion of Kaneka MX133 in MEK and 0.27 grams of a 50% solids solution of EMI in MEK. The dispersion was filtered through three layers of 10 micron filter bag material. The final composition was:

| Ingredient | Dry weight % |
|---|---|
| BaTiO₃ | 69.57 |
| ESD-1819 | 12.47 |
| Vamac ® MR | 2.64 |
| MX-133 | 14.07 |
| EMI | 0.31 |
| Dispersant | 0.95 |

Coatings were made with 4 and 8 mil doctor knifes on Gould RA black treat copper foil that was adhered to a glass plate. The coated samples were dried for 10 min at 80° C. The 0.5 mil thick samples from the 2 mil doctor knife coatings were vacuum laminated to the treated side of Gould RA black treat copper foil in a hot press to form the planar capacitor laminate with a peel strength of 0.98 Kg/cm. The thicker dielectric samples were cured in a 170° C. forced draft oven for one hour, and the copper was etched to obtain a 1.34 mil thick free-standing sheet of cured epoxy which had an elongation-to-break of 3.6% and a tensile strength of 572 Kg/cm2. Electrical testing of capacitors of the 15.0 micron dielectric thick samples gave a capacitance density of 0.84 nF/cm² and a loss tangent of 0.0192, a dielectric constant of 13.9 and an average leakage current at 750 volts DC test voltage of 0.012±0.003 μamp/cm² for the 8 capacitors.

### Example 5

EXAMPLE 5 illustrates a planar capacitor filled with a high level of barium titanate to increase the capacitance density. The composition was prepared by mixing a media milled dispersion with the rest of the composition ingredients. The dispersion was prepared from a mixture of:

| Ingredient | Grams |
|---|---|
| BaTiO₃ filler B | 30.00 |
| Dispersant 2 | 0.58 |
| ESD-1819 (60% solids in MEK) | 0.60 |
| Vamac ® MR (30% solids in MEK) | 2.13 |
| MEK | 36.0 |

The mixture was media milled for 4 hours in a bottle that was half filled with 0.635 cm cylinders. The bottle was packed in a one gal bottle and placed on a jar roller that was set at 80 RPM so that the small bottle tumbled end over end. To this dispersion was added 4.54 grams of a 60% solids solution of ESD-1819 in MEK, 5.78 grams of a 60% solids dispersion of Kaneka MX133 in MEK and 0.16 grams of a 50% solids solution of EMI in MEK. The dispersion was filtered through three layers of 10 micron filter bag material. The final composition was:

| Ingredient | Dry weight % |
|---|---|
| BaTiO₃ | 79.98 |
| ESD-1819 | 8.22 |
| Vamac ® MR | 1.72 |
| MX-133 | 9.25 |
| EMI | 0.21 |
| Dispersant | 0.62 |

Coatings were made with 4 and 8 mil doctor knifes on Gould RA black treat copper foil that was adhered to a glass plate. The coated samples were dried for 10 min at 80° C. The 0.5 mil thick samples from the 2 mil doctor knife coatings were vacuum laminated to the treated side of Gould RA black treat copper foil in a hot press to form the planar capacitor laminate with a peel strength of 0.66 Kg/cm. The thicker dielectric samples were cured in a 170° C. forced draft oven for one hour, and the copper was etched to obtain a 1.07 mil thick free-standing sheet of cured epoxy which had an elongation-to-break of 1.9% and a tensile strength of 717 Kg/cm2. Electrical testing of capacitors of the 12.8 micron dielectric thick samples gave a capacitance density of 1.66 nF/cm² and a loss tangent of 0.20, a dielectric constant of 23.9 and a leakage current at 750 volts DC test voltage of 0.031±0.014 μamp/cm² for the 11 capacitors.

### Example 6

EXAMPLE 6 illustrates a planar capacitor filled with a high level of barium titanate that has a central polyaramide film layer to improve tear resistance of etched laminate. Coatings of EXAMPLE 5 dispersion were made with a one mil doctor knife to obtain close to 4 micron thick dielectric coatings. After a 10 min dry time at 80° C. two pieces of the coated copper were vacuum laminated with a 3.8 micron thick polyaramide film between them in a hot press to form the planar capacitor laminate. After etching of the copper, the three layer composition had noticeably more resistance to tearing than the 12.8 micron thick dielectric of EXAMPLE 5. Electrical testing of capacitors of the 13.4 micron dielectric thick samples gave a capacitance density of 0.64 nF/cm² and a loss tangent of 0.0212, a dielectric constant of 9.7 and a leakage current with no deviation at 750 volts DC test voltage of 0.002 μamp/cm² for the 10 samples.

### Examples 7-10

EXAMPLES 7-10 illustrate highly filled flexible epoxy compositions with different phenolic resins. Each dispersion was prepared as EXAMPLE 7 where the phenolic resin, ESD-1819, that was used for EXAMPLE 7, was replaced with different phenolic resins for EXAMPLES 8-10. For EXAMPLE 7 a dispersion was prepared from a mixture of:

| Ingredient | Grams |
|---|---|
| TiO₂ R-706 | 39.13 |
| Dispersant 2 | 1.84 |
| ESD-1819 (60% solids in MEK) | 1.71 |
| MEK | 47.13 |

The mixture was media milled for 4 hours in a bottle that was half filled with 0.635 cm cylinders. The bottle was packed in a one gal bottle and placed on a jar roller that was set at 80 RPM so that the small bottle tumbled end over end. To this dispersion was added 15.26 grams of a 60% solids solution of ESD-1819 in MEK, 8.28 grams of a 60% solids solution of SU-8 epoxy in MEK, 23.08 grams of a 21.91% solids dispersion of Kevlar® nanopulp in acetone, 14.75 grams of a 30% solids solution of Vamac MR in MEK and 0.47 grams of a 50% solids solution of EMI in MEK. The dispersion was filtered through three layers of 10 micron filter bag material. The final composition was:

| Ingredient | Dry weight % |
|---|---|
| TiO₂ | 60.45 |
| ESD-1819 | 15.73 |
| SU-8 | 7.67 |
| Vamac ® MR | 6.84 |
| Kevlar ® nanopulp | 7.81 |
| EMI | 0.36 |
| Dispersant | 1.14 |

For EXAMPLES 8-10 the phenolic resin of the EXAMPLE 7 composition was replaced with:

| EXAMPLE | Phenolic Resin |
|---|---|
| 8 | SD-1502 |
| 9 | SD-1708 |
| 10 | ESD-1817 |

Coatings were made with an 8 mil doctor knife on Gould RA black treat copper foil that was adhered to a glass plate. After a 10 min dry time at 80° C. the coated copper was cured in a 170° C. forced draft oven for one hour and the copper was etched to obtain free-standing sheets of cured epoxy, which had the thickness, elongation-to-break, and tensile strength of:

| | | Elongation- | Tensile |
|---|---|---|---|
| | Thickness | to-break | Strength |
| EXAMPLE | (mils) | (%) | (Kg/cm²) |
| 7 | 1.2 | 5.1 | 464 |
| 8 | 1.3 | 6.7 | 352 |
| 9 | 1.3 | 5.9 | 375 |
| 10 | 1.4 | 4.3 | 321 |

### Example 11

EXAMPLE 11 illustrates a highly filled boron nitride-filled flexible epoxy composition for a thermal laminate application. The composition was prepared by mixing a media milled dispersion with the rest of the composition ingredients. The dispersion was prepared from a mixture of:

| Ingredient | Grams |
|---|---|
| BN | 30.00 |
| Dispersant 2 | 0.99 |
| Vamac ® VCX 1014 (30% solids in MEK) | 5.68 |
| Vamac ® GMA (30% solids in MEK) | 5.68 |
| MEK | 36.35 |

The mixture was media milled for 16 hours in a bottle that was half filled with 0.635 cm cylinders. The bottle was packed in a one gal bottle and placed on a jar roller that was set at 80 RPM so that the small bottle tumbled end over end. To this dispersion was added 7.11 grams of a 60% solids solution of ESD-1819 in MEK, 7.89 grams of a 60% solids dispersion of Kaneka MX133 in MEK and 0.23 grams of a 50% solids solution of EMI in MEK. The dispersion was filtered through a 400 mesh screen. The final composition was:

| Ingredient | Dry weight % |
|---|---|
| BN | 69.91 |
| ESD-1819 | 9.94 |
| Vamac ® MR | 3.97 |
| Vamac ® GMA | 3.97 |
| MX-133 | 11.03 |
| EMI | 0.27 |
| Dispersant | 0.91 |

Coatings were made with a 7 mil doctor knife on Gould RA black treat copper foil that was adhered to a glass plate. After a 10 min dry time at 80° C. the coated copper was vacuum laminated to the treated side of non-coated Gould RA black treat copper foil in a hot press to form a thermal laminate. The samples had peel strength on 0.43 Kg/cm. Etched samples were 1.8 mils thick and could be handled without cracking.

### Example 12

EXAMPLE 12 illustrates a highly filled boron nitride-filled flexible epoxy composition for a thermal laminate application. The composition was prepared by mixing a media milled dispersion with the rest of the composition ingredients. The dispersion was prepared from a mixture of:

| Ingredient | Grams |
|---|---|
| BN | 39.06 |
| Dispersant 2 | 3.29 |
| SU-8 (60% solids in MEK) | 4.08 |
| MEK | 36.35 |

The mixture was media milled for 16 hours in a bottle that was half filled with 0.635 cm cylinders. The bottle was packed in a one gal bottle and placed on a jar roller that was set at 80 RPM so that the small bottle tumbled end over end. To this dispersion was added 10.53 grams of a 60% solids solution of ESD-1819 in MEK, 5.07 grams of a 60% solids dispersion of Epon® 1007F in MEK, 0.98 grams of a 60% solids solution of SU-8 in MEK, 8.09 grams of a 30% solids solution of Vamac® VCX 1014 in MEK, 8.10 grams of a 30% solids solution of Vamac® GMA in MEK and 0.33 grams of a 50% solids solution of EMI in MEK. The dispersion was filtered through a piece cut from a 10 micron filter bag. The final composition was:

| Ingredient | Dry weight % |
|---|---|
| BN | 67.59 |
| ESD-1819 | 10.93 |
| Epon ® 1007F | 5.26 |
| SU-8 | 5.25 |
| Vamac ® MR | 4.20 |
| Vamac ® GMA | 4.20 |
| EMI | 0.29 |
| Dispersant | 2.28 |

2 mil thick doctor knife coatings were made on Gould RA black treat copper foil that was adhered to a glass plate. After a 10 min dry time at 80° C. two pieces of the coated copper were vacuum laminated together in a hot press to form a thermal laminate, which had a Z-axis thermal conductivity of 1.2 W/m° K.

### Example 13

EXAMPLE 13 illustrates a flame retardant flexible epoxy composition for a flexible adhesive application. The composition was prepared by mixing a media milled dispersion with the rest of the composition ingredients. The dispersion was prepared from a mixture of:

| Ingredient | Grams |
|---|---|
| Melapur ® 200 | 5.02 |
| Dispersant 2 | 0.82 |
| Vamac ® MR (30% solids in MEK) | 9.08 |
| ESD-1819 (60% solids in MEK) | 2.14 |
| MEK | 14.55 |

The mixture was media milled for 16 hours in a bottle that was half filled with 0.635 cm cylinders. The bottle was packed in a one gal bottle and placed on a jar roller that was set at 80 RPM so that the small bottle tumbled end over end. To this dispersion was added 19.12 grams of 60% solids ESD-1819 solution in MEK, 24.29 grams of 60% solids solution of Kaneka MX 133 in MEK, 0.15 grams of benzotriazole and 0.56 grams of a 50% solids solution of EMI in MEK. The dispersion was filtered through a 400 mesh screen. The final composition was:

| Ingredient | Dry weight % |
|---|---|
| Melapur ® 200 | 14.01 |
| ESD-1819 | 35.60 |
| Kaneka MX 133 | 40.67 |
| Vamac ® MR | 7.60 |
| EMI | 0.78 |
| Benzotriazole | 0.42 |
| Dispersant | 0.92 |

Coatings were made with a 5 mil doctor knife on 1 mil thick Kapton® film and onto red oxide-treated copper foil, and dried for 10 min at 80° C. to give a dried adhesive thickness of 1.0 mil. The coated Kapton® film was vacuum laminated to Gould RA black treat copper foil. The flexible adhesive had peel strength of 0.64 Kg/cm. Etched samples passed the UL94 VTM-0 flame test for thin materials, indicating that the adhesive composition has a V-0 rating by this test. The adhesive coated on copper foil was cured in a 170° C. forced draft oven for 1 hour and the copper etched off to yield a free-standing film. The sample had an elongation to break of 12.2% and a tensile strength of 470 Kg/cm².

### Comparative Example 1

COMPARATIVE EXAMPLE 1 illustrates that a Vamac®-free highly filled composition does not have good flexibility. The COMPARATIVE EXAMPLE is analogous to EXAMPLE 3. The composition was prepared by mixing a media milled dispersion with the rest of the composition ingredients. The dispersion was prepared from a mixture of:

| Ingredient | Grams |
|---|---|
| TiO₂ R-706 | 75.00 |
| Dispersant 2 | 3.52 |
| SD-1819 (60% solids in MEK) | 3.25 |
| MEK | 93.75 |

The mixture was media milled for 4 hours in a bottle that was half filled with 0.635 cm cylinders. The bottle was packed in a one gal bottle and placed on a jar roller that was set at 80 RPM so that the small bottle tumbled end over end. To 50.00 grams of this dispersion was added 8.36 grams of a 60% solids solution of ESD-1819 in MEK, 5.10 grams of a 60% solids solution of Epon® 1007F in MEK, 4.55 grams of a 60% solids solution of SU-8 epoxy resin, 12.63 grams of a 21.91% solids dispersion of Kevlar® nanopulp in acetone and 0.25 grams of a 50% solids solution of EMI in MEK. The dispersion was filtered through three layers of 10 micron filter bag material. The final composition was:

| Ingredient | Dry weight % |
|---|---|
| TiO₂ | 59.31 |
| ESD-1819 | 15.47 |
| SU-8 | 7.58 |
| Epon ® 1007F | 8.50 |
| Kevlar ® nanopulp | 7.68 |
| EMI | 0.35 |
| Dispersant | 1.11 |

Coatings were made with 2 and 7 mil doctor knifes on Gould RA black treat copper foil that was adhered to a glass plate. The coated samples were dried for 10 min at 80° C. The samples were cured in a 170° C. forced draft oven for one hour, and the copper was etched to obtain a 0.5 mil and 1.39 mil thick free-standing sheet of cured epoxy. The thick sample had an elongation-to-break of 1.87% and a tensile strength of 752 Kg/cm2. The thin sample was prone to breaking upon etching.

### Comparative Example 2

COMPARATIVE EXAMPLE 2 illustrates that a highly filled epoxy composition for a planar capacitor application from the patent literature which does not contain Vamac®. This composition does not have good flexibility, but does have low leakage current at high test voltage. The composition was prepared by mixing a pre-made dispersion with the rest of the composition ingredients. The dispersion was prepared from a mixture of:

| Ingredient | Grams |
|---|---|
| TiO₂ R-706 | 154.82 |
| Dispersant 1 | 4.29 |
| SU8 (50% solids in MEK) | 46.76 |
| Epon ® 1001F (50% solids in MEK) | 35.08 |
| MEK | 159.09 |

The mixture was mixed with a Silverson Homogenizer at 5,000 RPM for 30 min. The dispersion was filtered through two layers of 10 micron bag filter material. To 200 grams of this dispersion was added a solution consisting of 14.31 grams of a 80% solids solution of SU-8 in MEK, 12.25 grams of a 70% solids solution of Epon® 1007F in MEK, 42.9 grams of a 40% solids solution of PKHH in MEK, 14.3 grams of a 10% solids solution of DICY in 2-methoxyethanol, and 0.05 grams of EMI. The dispersion was filtered through one layer of 10 micron filter bag material. The final composition was:

| Ingredient | Dry weight % |
|---|---|
| TiO₂ | 55.81 |
| SU-8 | 16.69 |
| Epon ® 1001F | 12.51 |
| PKHH | 12.37 |
| DICY | 1.03 |
| EMI | 0.04 |
| Dispersant | 1.55 |

Coatings were made with a 2 mil doctor knife on Gould RA black treat copper foil that was adhered to a glass plate. After a 10 min dry time at 80° C. the coated copper was vacuum laminated to the treated side non-coated of Gould RA black treat copper foil in a hot press to form the planar capacitor laminate. After photoresist processing, etching and stripping of the photoresist, 2.54 cm capacitors were obtained. Electrical testing of the 12.9 micron dielectric thick samples gave a capacitance density of 0.71 nF/cm², a dielectric constant of 10.29 and a leakage current at 500 volts DC test voltage of 0.04 μamp/ cm². Upon etching the copper from the capacitors most of the samples cracked during the process.

### Comparative Example 3

COMPARATIVE EXAMPLE 3 illustrates that high % elongation-to-break is obtained for an unfilled flexible epoxy composition that contains Vamac®, although the capacitance density is low. The composition was prepared from a solution of:

| Ingredient | Grams | Dry Weight % |
|---|---|---|
| SD-1819 (60% solids in MEK) | 35.05 | 42.07 |
| Kaneka MX-133 (60% solids in MEK) | 40.02 | 48.03 |
| Vamac ® MR (30% solids in MEK) | 14.94 | 8.97 |
| EMI (50% solids in MEK) | 0.93 | 0.93 |

Coatings were made with 1 and 4 mil doctor knifes on Gould RA black treat copper foil that was adhered to a glass plate. The coated samples were dried for 10 min at 80° C. The 0.5 mil thick samples from the 2 mil doctor knife coatings were vacuum laminated to the treated side of Gould RA black treat copper foil in a hot press to form the planar capacitor laminate with a peel strength of 1.29 Kg/cm. The thicker dielectric samples were cured in a 170° C. forced draft oven for one hour, and the copper was etched to obtain a 1.2 mil thick free-standing sheet of cured epoxy which had an elongation-to-break of 28.8% and a tensile strength of 470 Kg/cm2. Capacitors of 11.4 micron dielectric had a capacitance density of 0.26 nF/cm² and a loss tangent of 0.0066, a dielectric constant of 3.4 and a leakage current at 750 volts DC test voltage of 0.005 μamp/ cm².

### Comparative Example 4

COMPARATIVE EXAMPLE 4 illustrates a highly filled boron nitride-filled epoxy composition without Vamac® does not have good flexibility that is desired for a thermal laminate application. The composition was prepared by mixing a pre-made dispersion with the rest of the composition ingredients. The dispersion was prepared from a mixture of:

| Ingredient | Grams |
|---|---|
| BN | 25.00 |
| MEK | 30.3 |

The mixture was sonicated at −5° C. under nitrogen for 10 minutes, warmed to room temperature under nitrogen and to this dispersion was added 8.04 grams of a 60% solids solution of ESD-1819 in MEK, 9.82 grams of a 60% solids dispersion of Kaneka MX133 in MEK and 0.24 grams of a 50% solids solution of EMI in MEK. The dispersion was filtered through a 400 mesh screen. The final composition was:

| Ingredient | Dry weight % |
|---|---|
| BN | 69.77 |
| ESD-1819 | 13.46 |
| MX-133 | 16.44 |
| EMI | 0.33 |

Coatings were made with a 7 mil doctor knife on Gould RA black treat copper foil that was adhered to a glass plate. After a 10 min dry time at 80° C. the coated copper was vacuum laminated to the treated side of non-coated Gould RA black treat copper foil in a hot press to form a thermal laminate. After copper etching the 2 mil thick samples were noticeably more susceptible to cracks occurring during handling than samples of EXAMPLE 11. The samples had low peel strength of 0.25 Kg/cm.

### Comparative Example 5

COMPARATIVE EXAMPLE 5 illustrates that a filled flame retardant adhesive without Vamac® does not have good flexibility as compared to EXAMPLE 13. The composition was prepared by mixing a pre-made dispersion with the rest of the composition ingredients. The dispersion was prepared from a mixture of:

| Ingredient | Grams |
|---|---|
| Melapur ® 200 | 3.99 |
| Dispersant 2 | 0.64 |
| SU-8 60% solids in MEK | 1.91 |
| MEK | 17.50 |

The mixture was media milled for 16 hours in a bottle that was half filled with 0.25 inch cylinders. The bottle was packed in a one gal bottle and placed on a jar roller that was set at 80 RPM so that the small bottle tumbled end over end. To this dispersion was added 17.13 grams of a 60% solids solution of ESD-1819 in MEK, 21.68 grams of 60% solids solution of Kaneka MX133 in MEK, 0.13 grams of benzotriazole, and 0.48 grams of a 50% solids solution of EMI in MEK. The dispersion was filtered through a 400 mesh screen. The final composition was:

| Ingredient | Dry weight % |
|---|---|
| Melapur ® 200 | 13.74 |
| ESD-1819 | 39.33 |
| Kaneka MX133 | 44.77 |
| EMI | 0.83 |
| Benzotriazole | 0.45 |
| Dispersant | 0.88 |

Coatings were made with a 4 mil doctor knife on 1 mil thick Kapton® film and on red oxide-treated copper foil, and were dried for 10 min at 80° C. to give a dried adhesive thickness of 1.0 mil. The coatings on Kapton® film were vacuum laminated to Gould RA black treat copper foil. Etched samples passed the UL94 VTM-0 flame test for thin materials, indicating that the adhesive composition has a V-0 rating by this test. A free standing sheet of the adhesive after etching of the copper had a tensile strength of 728 Kg/cm2, but only 4.0% elongation-to-break, which is not sufficient for good flexibility for a flexible adhesive application. By comparison the elongation-to-break for the flame retardant adhesive for EXAMPLE 13, which contains Vamac® ethylene copolymer, is three times higher.

Note that not all of the activities described above in the general description or the examples are required, that a portion of a specific activity may not be required, and that further activities may be performed in addition to those described. Still further, the order in which each of the activities are listed are not necessarily the order in which they are performed. After reading this specification, skilled artisans will be capable of determining what activities can be used for their specific needs or desires.

In the foregoing specification, the invention has been described with reference to specific embodiments. However, one of ordinary skill in the art appreciates that various modifications and changes can be made without departing from the scope of the invention as set forth in the claims below. Accordingly, the specification is to be regarded in an illustrative rather than a restrictive sense and all such modifications are intended to be included within the scope of the invention.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as a critical, required, or essential feature or element of any or all the claims.

When an amount, concentration, or other value or parameter is given as either a range, preferred range or a list of upper values and lower values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. It is not intended that the scope of the invention be limited to the specific values recited when defining a range.

What is claimed is:

1. An epoxy composition comprising:
A. an epoxy resin present in an amount from 5 to 40 weight %;
B. a phenolic resin present in an amount from 5 to 50 weight %;
C. at least one ethylene copolymer elastomer present in an amount from 1 to less than 10 weight % wherein the elastomer comprises:
i.) 37 to 43 weight % ethylene; and
ii.) 55 to 63 weight % of acrylate comprised of 65 to 100 weight % methyl acrylate and 0 to 35 weight % ethyl acrylate, butyl acrylate or a mixture thereof;
D. a functional filler present in an amount from 10 to 88 weight %; and
E. an epoxy cure catalyst from 0.1 to 5 weight %.

2. An epoxy composition in accordance with claim 1, wherein the elastomer comprises 0.25 to 6 weight % of a mono alkyl ester of maleic acid, wherein the alkyl group is methyl, ethyl, propyl or butyl.

3. An epoxy composition in accordance with claim 1, wherein the elastomer comprises 0.25 to 9 weight % glycidyl methacrylate.

4. An epoxy composition in accordance with claim 1, further comprising at least one core shell polymer in an amount from 1 to 6 weight %, wherein the polymer has an elastomer core and the elastomer is selected from a group consisting of polybutadiene, a polybutadiene derivative, polystyrene butadiene copolymer and polysiloxane.

5. An epoxy composition in accordance with claim 1 further comprising polyaramide nanopulp in an amount from 1 to 3 weight %.

6. An epoxy composition in accordance with claim 1, wherein the functional filler is selected from a group consisting of TiO₂, Ta₂O₅, Hf₂O₅, Nb₂O₅, Al₂O₃, Steatite, BaTiO₃, SrTi0₃, BaSrTi0₃, PbZrTiO₃, PdLaTiO₃, PdLaTiO₃, PdLaZrTiO₃, PdMgNbO₃, CaCuTiO₃ and mixtures thereof.

7. An epoxy composition in accordance with claim 6, wherein the composition is used as a dielectric layer in a planar capacitor.

8. An epoxy composition in accordance with claim 1, wherein the functional filler is selected from a group consisting of aluminum oxide, silica, boron nitride, boron nitride coated aluminum oxide, granular alumina, granular silica, fumed silica, silicon carbide, aluminum nitride, aluminum oxide coated aluminum nitride, titanium dioxide, dicalcium phosphate, barium titanate, titanium diboride, cubic boron nitride, diamond, calcium fluoride, talc, zinc oxide and mixtures thereof.

9. An epoxy composition in accordance with claim 8, wherein the composition is used as a layer in a thermal laminate.

10. An epoxy composition in accordance with claim 1, wherein the functional filler is a halogen-free polyphosphate selected from a group consisting of melamine polyphosphate, melamine pyrophosphate, resorcinol polyphosphate and mixtures thereof.

11. An epoxy composition in accordance with claim 10, wherein the composition is used as a flame retardant adhesive composition.

12. An epoxy composition in accordance with claim 7, wherein the composition, when placed on a 1 mil thick polyimide film, passes a flame retardancy test defined by Underwriters Laboratories test number UL-94 VTM-0.
